(19) United States
(12) Patent Application Publication
(10) Pub. No.: US 2009/0102153 A1
(43) Pub. Date: Apr. 23, 2009

(54) DOUBLE PLATE TYPE UPPER ARM

(76) Inventor: Daewoo Jung, Seongnam-si (KR)

Correspondence Address: MORGAN, LEWIS & BOCKIUS LLP (SF), One Market, Spear Street Tower, Suite 2800, San Francisco, CA, 94105, US

(21) Appl. No.: 11/956,187

(22) Filed: Dec. 13, 2007

(30) Foreign Application Priority Data
Oct. 17, 2007 (KR) 10-2007-0104516

(51) Int. Cl. B60G 7/00

(52) U.S. Cl. 280/124.15

(57) ABSTRACT

An upper arm for a vehicle suspension includes a main plate and a subsidiary plate. The main plate includes a first bush fitting at a first end of the main plate, configured to be attached to a wheel knuckle; second and third bush fittings, spaced apart from each other at a second end of the main plate and configured to be attached to a vehicle body; and two walls at first and second sides of the main plate. The main plate and the walls define an open cross-section along a substantial portion of the main plate. The subsidiary plate is attached to the second end of the main plate. The main plate, the walls, and the subsidiary plate define a closed cross-section at the second end of the main plate.

### CROSS-REFERENCE TO RELATED APPLICATIONS

The present application is based on, and claims priority from, Korean Application Serial Number 10-2007-0104516, filed on Oct. 17, 2007, the disclosure of which is hereby incorporated by reference herein in its entirety.

### FIELD OF THE INVENTION

The present invention relates to a double plate type upper arm for a vehicle suspension.

### BACKGROUND OF THE INVENTION

A suspension system prevents a vehicle from joggling caused by irregularities of the road, and adjusts vehicle height or damping force based on running conditions, such as road conditions and vehicle speed.

A suspension system generally includes springs, shock absorbers, stabilizers, and a pair of arms, one lower and one upper, attached between the vehicle body and the wheels. The suspension system mainly functions to adjust a spring constant, a damping force, and the vehicle height. Further, the suspension system functions to improve the ride comport and stability of a vehicle.

The upper arm is limited to being mounted on certain components. For example, a double wishbone type suspension system has very little design freedom.

The above information disclosed in this Background section is only for enhancement of understanding of the background of the invention and therefore it may contain information that does not form the prior art that is already known in this country to a person of ordinary skill in the art.

### SUMMARY OF THE INVENTION

An upper arm for a vehicle suspension includes a main plate and a subsidiary plate. The main plate includes a first bush fitting at a first end of the main plate, configured to be attached to a wheel knuckle; second and third bush fittings, spaced apart from each other at a second end of the main plate and configured to be attached to a vehicle body; and two walls at first and second sides of the main plate. The main plate and the walls define an open cross-section along a substantial portion of the main plate. The subsidiary plate is attached to the second end of the main plate. The main plate, the walls, and the subsidiary plate define a closed cross-section at the second end of the main plate.

The main plate may be Y-shaped. The second end may curve toward the first end. The ends of the walls may curl outward. At least one depression may be provided on a surface of the main plate.

The subsidiary plate may have a bottom part and a side part, the bottom part and the side part being attached at a rounded corner.

### BRIEF DESCRIPTION OF THE DRAWINGS

For a better understanding of the nature and objects of the present invention, reference should be made to the following detailed description with the accompanying drawings, in which:

FIGS. 1A and 1B are perspective views of a double plate type upper arm according to an embodiment of the present invention; and

FIGS. 2A and 2B are cross-sectional views taken along lines A-A and B-B of FIG. 1.

### DETAILED DESCRIPTION OF THE PREFERRED EMBODIMENTS

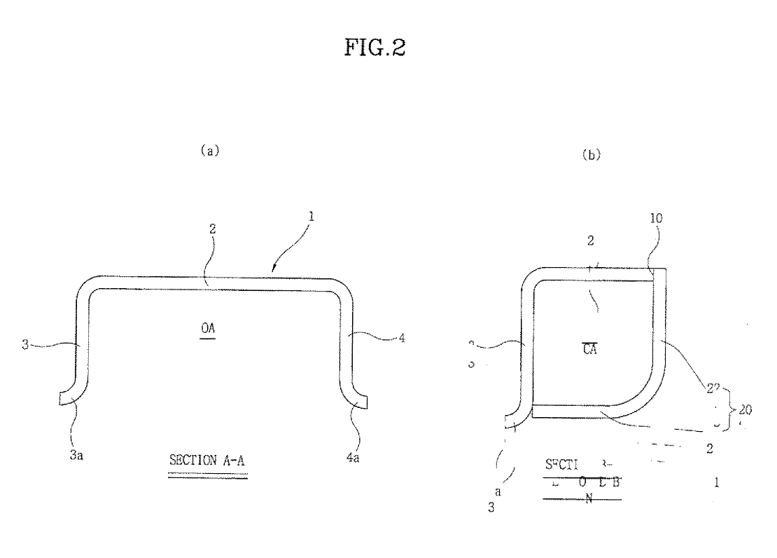

A preferred embodiment of the present invention will be described in detail below with reference to the accompanying drawings. A first mounted-bush fitting end 7 is provided at one end of a main plate-shaped member 1, and second and third mounted-bush fitting ends 8 and 9 are provided at the other end thereof. The upper arm is generally Y-shaped, with an opening OA (FIG. 2A) on its underside. A subsidiary plate-shaped member 20 is attached to opening portion OA at second and third mounted-bush fitting ends 8 and 9 of main plate-shaped member 1.

Subsidiary plate-shaped member 20 closes the side and bottom of second and third mounted-bush fitting ends 8 and 9, and thus forms closed portion CA (FIG. 21B) at second and third mounted-bush fitting ends 8 and 9.

A body part 2 of main plate-shaped member 1 is generally Y-shaped. Further, left and right side parts 3 and 4 of the main plate-shaped member 1 close off the sides of body part 2, so that opening portion OA is formed.

In addition, first and second mounting portions 5 and 6 are depressions on the upper surface of body part 2 and can have components mounted thereon. First and second mounting portions 5 and 6 may have various shapes, but it is preferable that each of the first and second mounting portions has a rectangular shape.

Further, left and right side parts 3 and 4 have curled portions 3a and 4a, which curl outward, at the ends thereof. Left and right side parts 3 and 4 do not extend all the way to first mounted-bush fitting end 7. The ends of left and right side parts 3 and 4 are arc shaped at second and third mounted-bush fitting ends 8 and 9.

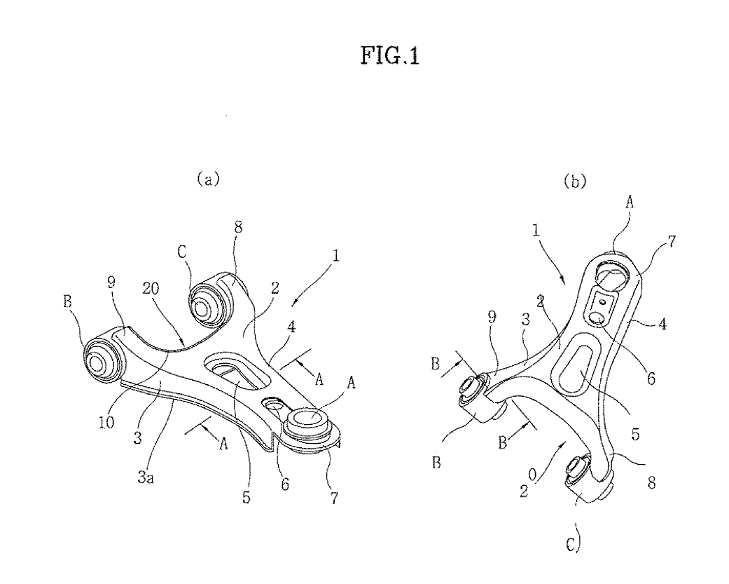

The portion between second and third mounted-bush fitting ends 8 and 9 is curved toward the inner portion of body part 2, that is, left and right connection portions 10 are curved toward body part 2 so that only second and third mounted-bush fitting ends 8 and 9 protrude from the left end of body part 2 in FIG. 1A, the bottom end in FIG. 1B.

Referring to FIG. 2B, subsidiary plate-shaped member 20 includes a bottom part 21 and a side part 22. The side part 22 is attached to the left and right connection portions 10. The corner connecting bottom part 21 and vertical part 22 has a gently rounded shape.

The upper arm is formed using main plate-shaped member 1. First mounted-bush fitting end 7 is fitted to the knuckle portion from the wheel and second and third mounted-bush fitting ends 8 and 9 are fitted to a vehicle body. Subsidiary plate-shaped member 20 is attached to the upper arm. Therefore, even though upper arm mainly has an open cross section, it is satisfactorily rigid.

The upper arm is formed using one main plate-shaped member 1. Then, subsidiary plate-shaped member 20 is attached to main plate-shaped member 1. Subsidiary plate-shaped member 20 is welded to left and right connection portions 10.

The upper arm described above can be applied to a double wishbone type thrust suspension system.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An upper arm for a vehicle suspension, comprising:
a main plate comprising:
a first bush fitting at a first end of the main plate, configured to be attached to a wheel knuckle;
second and third bush fittings, spaced apart from each other at a second end of the main plate and configured to be attached to a vehicle body; and
two walls at first and second sides of the main plate, wherein the main plate and the walls define an open cross-section along a substantial portion of the main plate; and
a subsidiary plate attached to the second end of the main plate, wherein the main plate, the walls, and the subsidiary plate define a closed cross-section at the second end of the main plate.

2. The arm as defined in claim 1, wherein the main plate is substantially Y-shaped.

3. The arm as defined in claim 1, wherein the second end curves toward the first end.

4. The arm as defined in claim 1, wherein the walls each comprise an end that curls outward.

5. The arm as defined in claim 1, wherein the main plate further comprises at least one depression on a surface thereof.

6. The arm as defined in claim 1, wherein the subsidiary plate comprises a bottom part and a side part, the bottom part and the side part being attached at a corner.

7. The arm as defined in claim 6, wherein the corner is rounded.
